(19) United States
(12) Patent Application Publication
(10) Pub. No.: US 2018/0139259 A1
(43) Pub. Date: May 17, 2018

(54) EMBEDDING HTML-5 AND JAVASCRIPT IN USER-DATA FIELD OF MPEG OR AVC TRANSPORT STREAM

(71) Applicant: Sony Corporation, Tokyo (JP)

(72) Inventor: Jeff Moguillansky, San Diego, CA (US)

(21) Appl. No.: 15/354,028

(22) Filed: Nov. 17, 2016

(51) Int. Cl. H04L 29/06

(52) U.S. Cl. CPC H04L 65/602; H04L 65/4069

(57) ABSTRACT

The user-data field specified in the MPEG and AVC transport stream standard is used to embed HTML-5 and/or Javascript for rendering a variety of content including subtitles, 2D, and 3D graphics, and interactive content including advertisements, shopping, and games. Also, high quality vector graphics can be rendered on the screen that scale to any resolution. Finally, the content can allow for user input and response, and can be applied for interactive content, entertainment, and games.

### FIELD

The present application relates to technically inventive, non-routine solutions that are necessarily rooted in computer technology and that produce concrete technical improvements.

### BACKGROUND

In the Moving Picture Expert Group (MPEG) and Advanced Video Coding (AVC) transport stream specifications, a “user-data” field is defined for carrying private data that does not otherwise conform to specific requirements in the specification. Specifically, as set forth in Annex H of ISO/IEC 13818-1: 2000 E, “private data is any user data which is not coded according to a standard specified by ITU-T | ISO/IEC and referred to in this Specification. The contents of this data is not and shall not be specified within this Recommendation | International Standard in the future. The STD defined in this Specification does not cover private data other than the demultiplex process. A private party may define each STD for private streams.”

### SUMMARY

As recognized herein and described further below, the above-discussed “user-data” field can be used to embed hypertext markup language 5 (HTML5) as well as Javascript for rendering content including advertisements, subtitles, 2D and 3D graphics, and interactive content including advertisements, shopping, and games. Other examples of content that can be rendered in this manner include high quality vector graphics that scale to any resolution, entertainment, and games. Use of the “user-data” field may also be leveraged to present 4K graphics in a high definition (HD) or standard definition (SD) stream, as well as for displaying an electronic program guide (EPG) directly through a transport stream.

Accordingly, in one aspect a device includes at least one computer medium that is not a transitory signal and that in turn includes instructions executable by at least one processor to enter into a format_identifier field of a user-data element a 32-bit descriptor indicating that the user-data element contains information pertaining hypertext markup language 5 (HTML5) and/or Javascript content. The instructions are executable to embed into the user-data element the information pertaining to the HTML5 and/or Javascript content, and to associate the user-data element with a Moving Picture Expert Group (MPEG) and/or Advanced Video Coding (AVC) transport stream (TS).

The format_identifier can be obtained from a Registration Authority.

In examples, the information pertaining to the HTML5 and/or Javascript content may include a network link to the HTML5 and/or Javascript content. Or, the information pertaining to the HTML5 and/or Javascript content may include the HTML5 and/or Javascript content itself.

Non-limiting examples of the content that may be rendered using the information in the user-data element include subtitles, graphics, interactive content, advertisements, computer games, and electronic program guides (EPG).

The instructions may be further executable to transmit the TS, and the device may further include the processor.

In another aspect, an assembly includes at least one processor, at least one display configured to be controlled by the processor, and at least one computer storage accessible to the processor and including instructions executable by the processor to receive a Moving Picture Expert Group (MPEG) and/or Advanced Video Coding (AVC) transport stream. The instructions are also executable to access a descriptor in a format_identifier field of a user-data element in the TS. The descriptor indicates that the user-data element contains information related to hypertext markup language 5 (HTML5) and/or Javascript content. The instructions can be executed to render, on the display, the content using the information in the user-data element.

In another aspect, a method includes entering into a format_identifier field of a user-data element a descriptor indicating that the user-data element contains information pertaining hypertext markup language 5 (HTML5) and/or Javascript content. The method also includes embedding into the user-data element the information pertaining to the HTML5 and/or Javascript content, and associating the user-data element with a Moving Picture Expert Group (MPEG) and/or Advanced Video Coding (AVC) transport stream (TS).

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example computer system in which present principles may be implemented;

FIG. 1A is a schematic diagram of a user-data field;

FIG. 2 is a flow chart of example logic for transmitting private data in an MPEG/AVC transport stream;

FIG. 3 is a flow chart of example logic for receiving private data from an MPEG/AVC transport stream; and

FIGS. 4-8 illustrate example types of content that can be embedded in the user-data field.

### DETAILED DESCRIPTION

This disclosure relates generally to computer ecosystems including aspects of computerized devices. A system herein including computerized devices may include server and client components, connected over a network such that data may be exchanged between the client and server components. The client components may include one or more computing devices such as portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community including but not limited to social networks to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers. A processor may be implemented by a digital signal processor (DSP), for example.

Software modules described by way of the flow charts and user interfaces herein can include various sub-routines, procedures, etc. Without limiting the disclosure, logic stated to be executed by a particular module can be redistributed to other software modules and/or combined together in a single module and/ or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optic and coaxial wires and digital subscriber line (DSL) and twisted pair wires.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

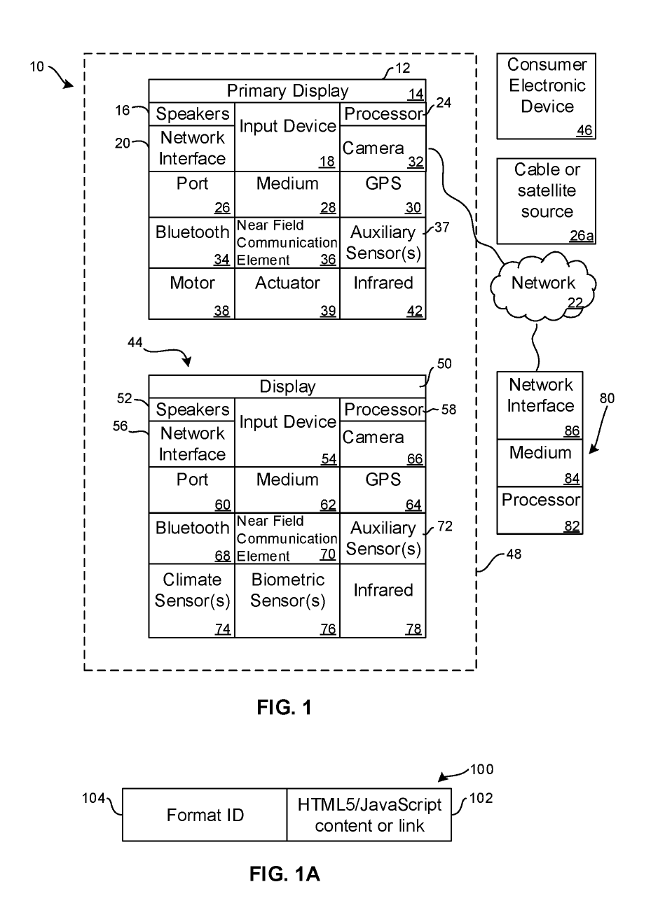

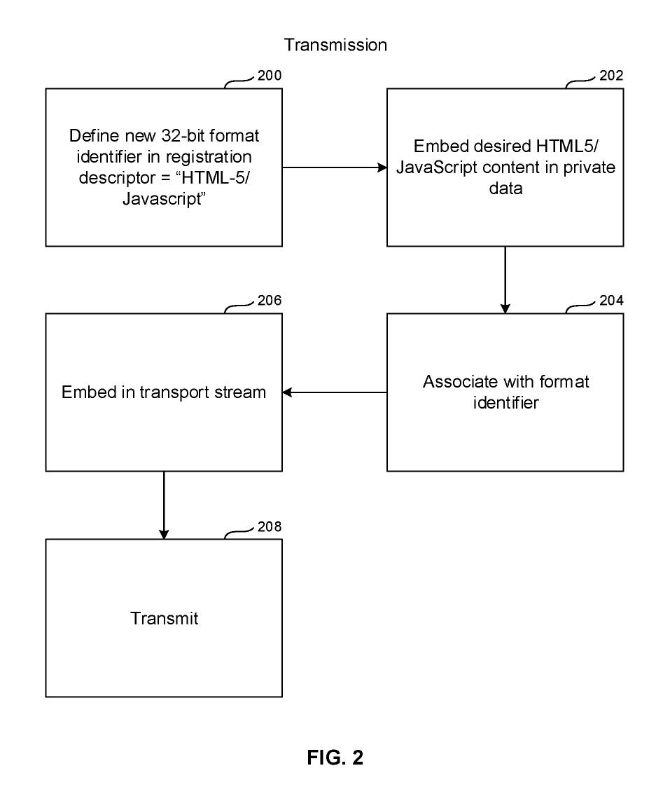

Now specifically referring to FIG. 1, an example system 10 is shown, which may include one or more of the example devices mentioned above and described further below in accordance with present principles. The first of the example devices included in the system 10 is an example computerized device 12.

The computerized device 12 may be an Android®-based system. The computerized device 12 alternatively may also include a computerized Internet enabled (“smart”) telephone, an IPTV, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the computerized device 12 and/or other computers described herein is configured to undertake present principles (e.g. communicate with other CE devices to undertake present principles, execute the logic described herein, and perform any other functions and/or operations described herein).

Accordingly, to undertake such principles the computerized device 12 can be established by some or all of the components shown in FIG. 1. For example, the computerized device 12 can include one or more displays 14 that may be implemented by a high definition or ultra-high definition “4K” or higher flat screen and that may or may not be touch-enabled for receiving user input signals via touches on the display. The computerized device 12 may include one or more speakers 16 for outputting audio in accordance with present principles, and at least one additional input device 18 such as e.g. an audio receiver/microphone for receiving input sound including but not limited to audible commands to the computerized device 12 to control the computerized device 12. The example computerized device 12 may also include one or more network interfaces 20 for communication over at least one network 22 such as the Internet, a WAN, a LAN, a PAN etc. under control of one or more processors 24. Thus, the interface 20 may be, without limitation, a Wi-Fi transceiver, which is an example of a wireless computer network interface, such as but not limited to a mesh network transceiver. The interface 20 may be, without limitation a Bluetooth transceiver, Zigbee transceiver, IrDA transceiver, Wireless USB transceiver, wired USB, wired LAN, Powerline or MoCA. It is to be understood that the processor 24 controls the computerized device 12 to undertake present principles, including the other elements of the computerized device 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the computerized device 12 may also include one or more input ports 26 such as, e.g., a high definition multimedia interface (HDMI) port or a USB port to physically connect (e.g. using a wired connection) to another CE device and/or a headphone port to connect headphones to the computerized device 12 for presentation of audio from the computerized device 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player containing content that might be regarded by a user as a favorite for channel assignation purposes described further below.

The computerized device 12 may further include one or more computer memories 28 such as disk-based or solid state storage that are not transitory signals, in some cases embodied in the chassis of the device as standalone devices or as a personal video recording device (PVR) or video disk player either internal or external to the chassis of the device for playing back AV programs or as removable memory media. Also in some embodiments, the computerized device 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the computerized device 12 is disposed in conjunction with the processor 24. However, it is to be understood that that another suitable position receiver other than a cellphone receiver, GPS receiver and/or altimeter may be used in accordance with present principles to e.g. determine the location of the computerized device 12 in e.g. all three dimensions.

In some embodiments the computerized device 12 may include one or more cameras 32 that may be, e.g., a thermal imaging camera, a digital camera such as a webcam, and/or a camera integrated into the computerized device 12 and controllable by the processor 24 to gather pictures/images and/or video in accordance with present principles. Also included on the computerized device 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the computerized device 12 may include one or more auxiliary sensors 37 (e.g., a motion sensor such as an accelerometer, gyroscope, cyclometer, or a magnetic sensor, an infrared (IR) sensor for receiving IR commands or other signals from a remote control or laser, an optical sensor, a speed and/or cadence sensor, a gesture sensor (e.g. for sensing gesture command), etc.) providing input to the processor 24. The computerized device 12 may include one or more motors 38, which may be a battery-powered motor, and one or more actuators 39 coupled to the motor 38 and configured to cause the device 12 to ambulate.

In addition to the foregoing, it is noted that the computerized device 12 may also include an infrared (IR) transmitter and/or IR receiver and/or IR transceiver 42 such as a laser or an IR data association (IRDA) device. A battery (not shown) may be provided for powering the computerized device 12.

Still referring to FIG. 1, in addition to the computerized device 12, the system 10 may include one or more other computer device types that may include some or all of the components shown for the computerized device 12 and that may wirelessly communicate with the device 12 to control it. In one example, a first device 44 and a second device 46 are shown and may include similar components as some or all of the components of the computerized device 12. Fewer or greater devices may be used than shown.

In the example shown, to illustrate present principles all three devices 12, 44, 46 are assumed to be members of a local network in, e.g., a dwelling 48, illustrated by dashed lines.

The example non-limiting first device 44 may include one or more touch-sensitive surfaces 50 such as a touch-enabled video display for receiving user input signals via touches on the display. The first device 44 may include one or more speakers 52 for outputting audio in accordance with present principles, and at least one additional input device 54 such as e.g. an audio receiver/microphone for e.g. entering audible commands to the first device 44 to control the device 44. The example first device 44 may also include one or more network interfaces 56 for communication over the network 22 under control of one or more processors 58. Thus, the interface 56 may be, without limitation, a Wi-Fi transceiver, which is an example of a wireless computer network interface, including mesh network interfaces. It is to be understood that the processor 58 controls the first device 44 to undertake present principles, including the other elements of the first device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first device 44 may also include one or more input ports 60 such as, e.g., a HDMI port or a USB port to physically connect (e.g. using a wired connection) to another computer device and/or a headphone port to connect headphones to the first device 44 for presentation of audio from the first device 44 to a user through the headphones. The first device 44 may further include one or more tangible computer readable storage medium 62 such as disk-based or solid state storage. Also in some embodiments, the first device 44 can include a position or location receiver such as but not limited to a cellphone and/or GPS receiver and/or altimeter 64 that is configured to e.g. receive geographic position information from at least one satellite and/or cell tower, using triangulation, and provide the information to the device processor 58 and/or determine an altitude at which the first device 44 is disposed in conjunction with the device processor 58. However, it is to be understood that that another suitable position receiver other than a cellphone and/or GPS receiver and/or altimeter may be used in accordance with present principles to e.g. determine the location of the first device 44 in e.g. all three dimensions.

Continuing the description of the first device 44, in some embodiments the first device 44 may include one or more cameras 66 that may be, e.g., a thermal imaging camera, a digital camera such as a webcam, etc. Also included on the first device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first device 44 may include still other sensors such as e.g. one or more climate sensors 74 (e.g. barometers, humidity sensors, wind sensors, light sensors, temperature sensors, etc.) and/or one or more biometric sensors 76 providing input to the device processor 58. In addition to the foregoing, it is noted that in some embodiments the first device 44 may also include an infrared (IR) transmitter and/or IR receiver and/or IR transceiver 42 such as a laser or an IR data association (IRDA) device. A battery may be provided for powering the first device 44. The device 44 may communicate with the computerized device 12 through any of the above-described communication modes and related components.

The second device 46 may include some or all of the components described above.

Now in reference to the afore-mentioned at least one server 80, it includes at least one server processor 82, at least one computer memory 84 such as disk-based or solid state storage, and at least one network interface 86 that, under control of the server processor 82, allows for communication with the other devices of FIG. 1 over the network 22, and indeed may facilitate communication between servers, controllers, and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server, and may include and perform “cloud” functions such that the devices of the system 10 may access a “cloud” environment via the server 80 in example embodiments. Or, the server 80 may be implemented by a game console or other computer in the same room as the other devices shown in FIG. 1 or nearby.

FIG. 1A shows an example user-data field 100 that includes a private data element 102 containing HTML5/Javascript content and/or a link to the HTML5/Javascript content. To identify that the private data element 102 contains information pertaining to the HTML5/Javascript content, a registration_descriptor field 104 is associated with the private data field 102 and includes a format_identifier 106 that uniquely and unambiguously identifies the format of the private data to be HTML5/Javascript.

The format_identifier 106 may be a 32-bit value obtained from a Registration Authority as designated by ISO/IEC JTC 1/SC 29, incorporated herein by reference.

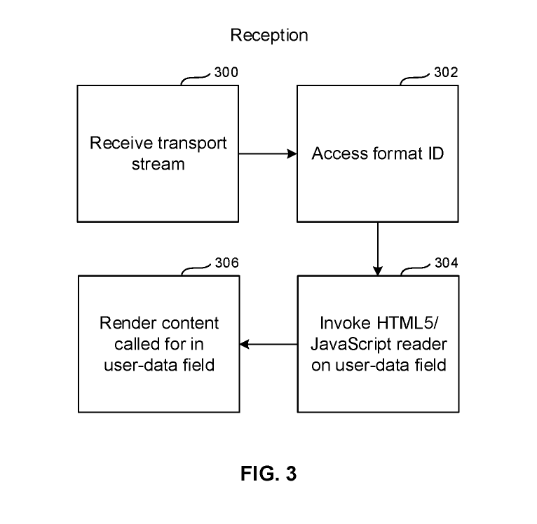

FIG. 2 illustrates. At block 200 a novel (per present principles) format_ID is defined to mean that the data in the appended private data field includes HTML5 and/or JavaScript. At block 202, either a link to, or the HTML5/Javascript content itself, is embedded in a private data field which is associated at block 204 with a registration_descriptor field containing the format_ID defined in block 200. The registration_descriptor field 104 with associated private data field 102 are then embedded in a MPEG/AVC TS at block 206 and transmitted with the TS at block 208.

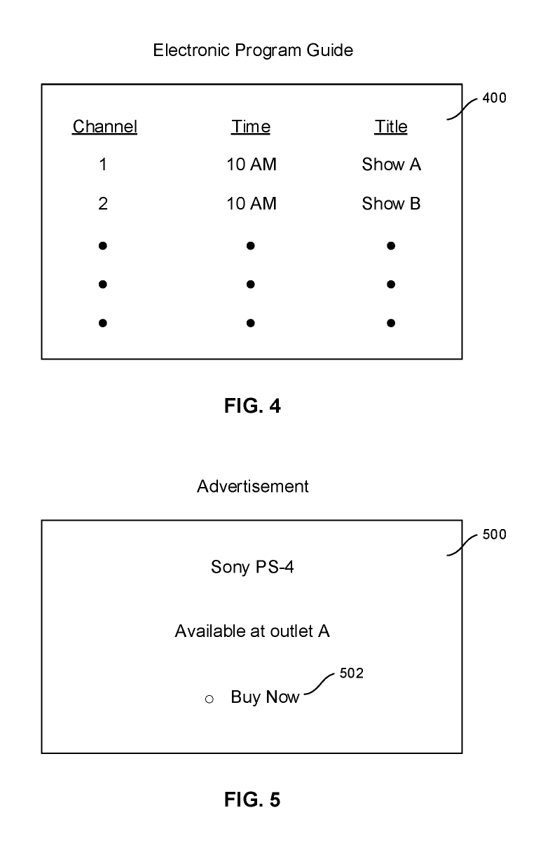

FIG. 3 illustrates the reception logic of a receiver. Commencing at block 300, the TS is received and the format_ID 106 accessed at block 302. This may invoke, at block 304, an appropriate HTML5/Javascript reader such as a parser or other control to read the information in the private data field of the user-data field. The content in the private data field is then rendered either by accessing a network site identified by a link in the private data filed or by rendering the HTML5/Javascript content in the private data field at block 306.

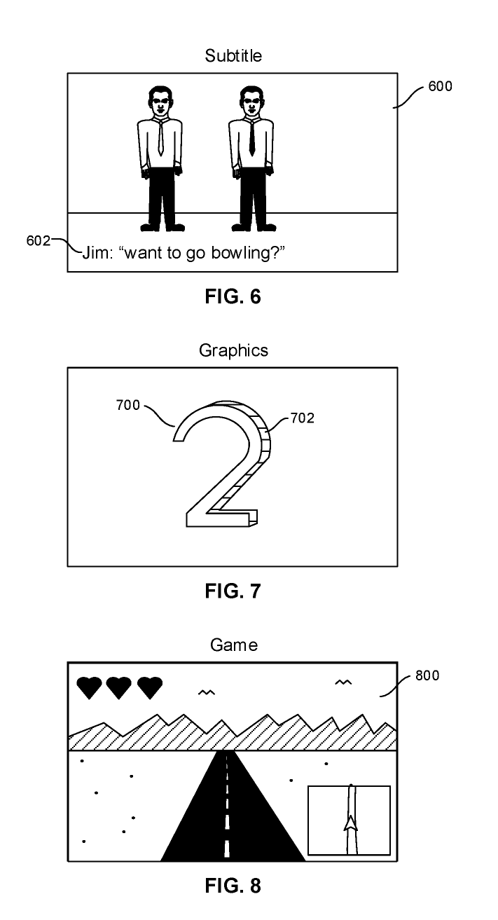

FIGS. 4-8 illustrate various example content types that may be transmitted and rendered according to disclosure above on any of the displays disclosed herein. An EPG 400 (or link thereto) (FIG. 4) may be included in the private data field. Or, an advertisement 500 (or link thereto) (FIG. 5) may be included in the private data field along with, if desired, an interactive control element 502 that may be selected to execute an indicated action.

Yet again, the TS may include a movie 600 and the private data field can include subtitles 602 (or link thereto) associated with the movie. Or, 2D or 3D graphics 700 (or link thereto) may be carried in the private data field. In the example of FIG. 7, the graphics 700 are 3D as indicated by the shading 702. Still further, a computer game 800 (or link thereto) may be carried in the private data field.

The HTML and JavaScript can be displayed on the screen using a frameless, transparent browser window, and can be used for rendering subtitles, 2D, and 3D graphics, and interactive content including advertisements, shopping, and games. It can be used to render high quality vector graphics on the screen that scale to any resolution. Finally, the content can allow for user input and response, and can be applied for interactive content, entertainment, and games. Present principles are also suitable for displaying 4K graphics in a regular HD or SD stream, and can be used for displaying a guide directly through a transport stream.

Thus, the above-discussed “user-data” field can be used to embed hypertext markup language 5 (HTML5) as well as Javascript for rendering content including advertisements, subtitles, 2D and 3D graphics, and interactive content including advertisements, shopping, and games. Other examples of content that can be rendered in this manner include high quality vector graphics that scale to any resolution, entertainment, and games. Use of the “user-data” field may also be leveraged to present 4K graphics in a high definition (HD) or standard definition (SD) stream, as well as for displaying an electronic program guide (EPG) directly through a transport stream.

While particular techniques and machines are herein shown and described in detail, it is to be understood that the subject matter which is encompassed by the present invention is limited only by the claims.

What is claimed is:

1. A device comprising:
at least one computer medium that is not a transitory signal and that comprises instructions executable by at least one processor to:
enter into a format_identifier field of a user-data element a 32-bit descriptor indicating that the user-data element contains information pertaining hypertext markup language 5 (HTML5) and/or Javascript content;
embed into the user-data element the information pertaining to the HTML5 and/or Javascript content; and
associate the user-data element with a Moving Picture Expert Group (MPEG) and/or Advanced Video Coding (AVC) transport stream (TS).

2. The device of claim 1, wherein the format_identifier is obtained from a Registration Authority.

3. The device of claim 1, wherein the information pertaining to the HTML5 and/or Javascript content includes a network link to the HTML5 and/or Javascript content.

4. The device of claim 1, wherein the information pertaining to the HTML5 and/or Javascript content includes the HTML5 and/or Javascript content.

5. The device of claim 1, wherein the HTML5 and/or Javascript content includes subtitles.

6. The device of claim 1, wherein the HTML5 and/or Javascript content includes graphics.

7. The device of claim 1, wherein the HTML5 and/or Javascript content includes interactive content.

8. The device of claim 1, wherein the HTML5 and/or Javascript content includes at least one advertisement.

9. The device of claim 1, wherein the HTML5 and/or Javascript content includes at least one computer game.

10. The device of claim 1, wherein the HTML5 and/or Javascript content includes an electronic program guide (EPG).

11. The device of claim 1, wherein the instructions are executable to transmit the TS.

12. The device of claim 1, comprising the at least one processor.

13. An assembly comprising:
at least one processor;
at least one display configured to be controlled by the processor; and
at least one computer storage accessible to the processor and including instructions executable by the processor to:
receive a Moving Picture Expert Group (MPEG) and/or Advanced Video Coding (AVC) transport stream;
access a descriptor in a format_identifier field of a user-data element in the TS, the descriptor indicating that the user-data element contains information related to hypertext markup language 5 (HTML5) and/or Javascript content; and
render, on the display, the content using the information.

14. The assembly of claim 13, wherein the information pertaining to the HTML5 and/or Javascript content includes a network link to the HTML5 and/or Javascript content.

15. The assembly of claim 13, wherein the information pertaining to the HTML5 and/or Javascript content includes the HTML5 and/or Javascript content.

16. A method comprising:
entering into a format_identifier field of a user-data element a descriptor indicating that the user-data element contains information pertaining hypertext markup language 5 (HTML5) and/or Javascript content;
embedding into the user-data element the information pertaining to the HTML5 and/or Javascript content; and
associating the user-data element with a Moving Picture Expert Group (MPEG) and/or Advanced Video Coding (AVC) transport stream (TS).

17. The method of claim 16, wherein the information pertaining to the HTML5 and/or Javascript content includes a network link to the HTML5 and/or Javascript content.

18. The method of claim 16, wherein the information pertaining to the HTML5 and/or Javascript content includes the HTML5 and/or Javascript content.

19. The method of claim 16, comprising transmitting the TS.
